(19) United States
(12) Patent Application Publication
(10) Pub. No.: US 2026/0217238 A1
(43) Pub. Date: Jul. 30, 2026

(54) METHODS AND APPARATUS TO FACILITATE SETUP OF A LOAD-DISTRIBUTING TRAILER HITCH

(71) Applicant: Ford Global Technologies, LLC, Dearborn, MI (US)

(72) Inventors: Keith Weston, Canton, MI (US); Michael Alan McNees, Flat Rock, MI (US)

(21) Appl. No.: 19/038,344

(22) Filed: Jan. 27, 2025

(51) Int. Cl. B60W 30/02; B60W 30/14; B60W 50/14

(52) U.S. Cl. CPC B60W 30/02; B60W 30/146; B60W 50/14; B60W 2420/403; B60W 2420/408; B60W 2520/16

(57) ABSTRACT

Methods and apparatus to facilitate setup of a load-distributing trailer hitch are disclosed. An example apparatus includes at least one processor circuit to obtain sensor data from one or more sensors of a vehicle, the sensor data representative of distances to ground at respective locations of the vehicle, determine a pitch of the vehicle based on the sensor data, determine, based on the pitch, a load restoration metric associated with the vehicle, generate setup information based on a comparison of the load restoration metric to a target load restoration metric of the vehicle, and output the setup information via a user interface.

### FIELD OF THE DISCLOSURE

This disclosure relates generally to load-distributing trailer hitches and, more particularly, to methods and apparatus to facilitate setup of a load-distributing trailer hitch.

### BACKGROUND

A trailer can be coupled to a vehicle to increase a hauling capacity of the vehicle. In some cases, the trailer applies a load on the vehicle, which can affect a load distribution across front and rear axles of the vehicle and, as a result, affects steering and/or maneuvering capabilities of the vehicle. In some cases, a load-distributing hitch may be used to adjust the load distribution across the front and rear axles of the vehicle to restore a load on the front axle (e.g., on front wheels of the front axle).

### SUMMARY

An example apparatus disclosed herein includes interface circuitry, machine-readable instructions, and at least one processor circuit to be programmed by the machine-readable instructions to obtain sensor data from one or more sensors of a vehicle, the sensor data representative of distances to ground at respective locations of the vehicle, determine a pitch of the vehicle based on the sensor data, determine, based on the pitch, a load restoration metric associated with the vehicle, generate setup information based on a comparison of the load restoration metric to a target load restoration metric of the vehicle, and output the setup information via a user interface.

At least one example non-transitory machine-readable medium disclosed herein includes machine-readable instructions to cause at least one processor circuit to at least obtain sensor data from one or more sensors of a vehicle, the sensor data representative of distances to ground at respective locations of the vehicle, determine a pitch of the vehicle based on the sensor data, determine, based on the pitch, a load restoration metric associated with the vehicle, generate setup information based on a comparison of the load restoration metric to a target load restoration metric of the vehicle, and output the setup information via a user interface.

An example method disclosed herein includes obtaining sensor data from one or more sensors of a vehicle, the sensor data representative of distances to ground at respective locations of the vehicle, determining a pitch of the vehicle based on the sensor data, determining, based on the pitch, a load restoration metric associated with the vehicle, generating setup information based on a comparison of the load restoration metric to a target load restoration metric of the vehicle, and outputting the setup information via a user interface.

### BRIEF DESCRIPTION OF THE DRAWINGS

FIG. 1 illustrates an example vehicle implementing example setup control circuitry in accordance with teachings of this disclosure.

FIG. 2 is a block diagram of an example implementation of the setup control circuitry of FIG. 1.

FIG. 3 illustrates the example vehicle of FIG. 1 after an example trailer is coupled to the vehicle, but prior to adjustment of an example load-distributing hitch coupling the trailer to the vehicle.

FIG. 4 is a detailed view of the load-distributing hitch of FIG. 3.

FIG. 5 illustrates the example vehicle of FIGS. 1, 3, and/or 4 during and/or after adjustment of the load-distributing hitch.

FIG. 6 is a flowchart representative of example machine readable instructions and/or example operations that may be executed, instantiated, and/or performed by example programmable circuitry to implement the setup control circuitry of FIG. 2 to facilitate a trailer setup procedure.

FIG. 7 is a flowchart representative of example machine readable instructions and/or example operations that may be executed, instantiated, and/or performed by example programmable circuitry to implement the setup control circuitry of FIG. 2 to monitor load restoration of the vehicle during operation and/or travel.

FIG. 8 is a block diagram of an example processing platform including programmable circuitry structured to execute, instantiate, and/or perform the example machine readable instructions and/or perform the example operations of FIGS. 6 and/or 7 to implement the setup control circuitry of FIG. 2.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

When a trailer is coupled to a vehicle via a trailer hitch, the trailer applies a load onto a rear portion of the vehicle (e.g., between a rear axle of the vehicle and the trailer hitch). As a result of the applied load on the vehicle, a pitch of the vehicle may increase (e.g., such that a front portion of the vehicle is further from the ground compared to the rear portion of the vehicle), and the increase in pitch results in the load being transferred from a front axle to the rear axle of the vehicle. In some instances, a resulting load imbalance across the front and rear axles may increase a likelihood of trailer sway, reduce steering and/or braking responsiveness of the vehicle, and/or otherwise reduce maneuverability of the vehicle and trailer.

In some cases, when a load-distributing hitch is used to couple the trailer to the vehicle, the load-distributing hitch can be used to restore and/or shift the load to the front axle of the vehicle. This may be achieved, for instance, using load bars of the load-distributing hitch to provide a lifting force on the rear portion of the vehicle. As a result of the lifting force, a portion of the trailer load may be transferred and/or shifted from the rear axle to the front axle to achieve a target load restoration for the vehicle. Some techniques for achieving the target load restoration rely on the use of designated sensors (e.g., load sensors and/or ride height sensors) to estimate the load at respective axles of the vehicle. Installation of such designated sensors may necessitate an increase in weight and/or cost associated with the vehicle.

Examples disclosed herein provide techniques for load restoration of a vehicle using existing image-based and/or radar-based sensors of the vehicle. Example setup control circuitry disclosed utilizes sensor data from one or more cameras positioned on at least one of a front portion, a rear portion, or a B-pillar of the vehicle, a blind spot radar sensor (e.g., a blind spot information system (BLIS) radar sensor), and/or one or more B-pillar sensors (e.g., B-pillar camera, a B-pillar radar sensor, etc.) positioned on the B-pillar. In some examples, the setup control circuitry determines, based on the sensor data, distances to ground (e.g., heights) at respective locations of the vehicle, and determines a pitch of the vehicle based on the distances. In some examples, based on the pitch of the vehicle, the setup control circuitry determines whether a target load restoration for the vehicle is satisfied, or whether settings of a load-distributing hitch (e.g., the load-distributing hitch used to couple a trailer to the vehicle) are to be adjusted. Based on the determination, the setup control circuitry can generate and/or output example setup information to an operator of the vehicle to facilitate a trailer setup procedure. For example, the setup information can inform the operator whether the target load restoration is satisfied, and/or can instruct the operator whether and/or how hitch settings of the load-distributing hitch are to be adjusted (e.g., to achieve the target load restoration).

In some examples, by providing setup information to assist an operator during a trailer setup procedure (e.g., during adjustment of hitch settings of the load-distributing hitch), examples disclosed herein can ensure that a target load restoration for the vehicle is achieved, thus improving steering and/or maneuverability of the vehicle and the trailer during operation. Further, examples disclosed herein can continue monitoring the load restoration of the vehicle during operation of the vehicle and/or when a condition associated with the vehicle is detected (e.g., a trailer sway condition, a stopping condition, a load change condition, etc.). As a result, examples disclosed herein can notify the operator when a detected condition necessitates adjustment of the hitch settings in order to restore the load on the front wheels (e.g., to achieve the target load restoration). Additionally, by determining the load restoration using existing image-based and/or radar-based sensors of the vehicle, examples disclosed herein eliminate the need for installing designated sensors (e.g., ride height sensors, load sensors, etc.) for detecting the load restoration, thus reducing part costs and/or weight associated with the vehicle.

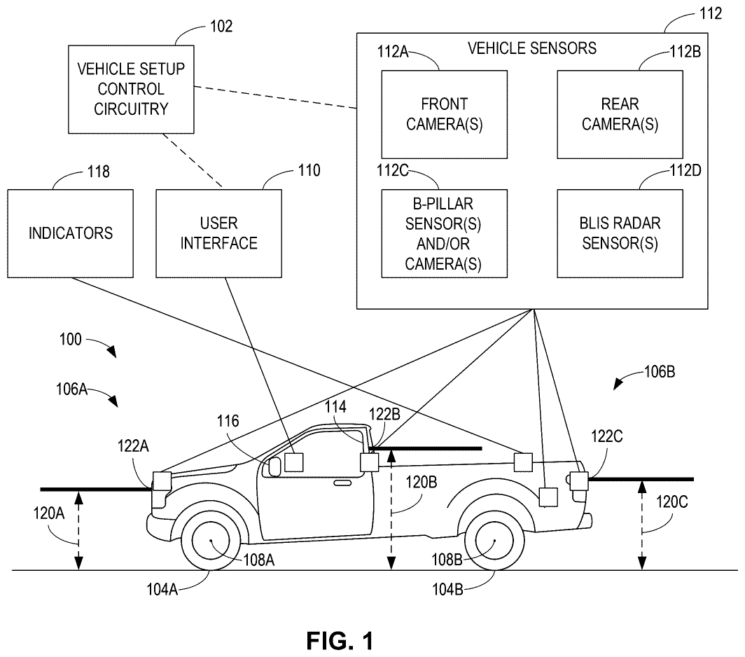

FIG. 1 illustrates an example vehicle 100 implementing example setup control circuitry 102 in accordance with teachings of this disclosure. In the illustrated example of FIG. 1, the vehicle 100 includes example front wheels 104A proximate a front portion 106A of the vehicle 100, and example rear wheels 104B proximate a rear portion 106B of the vehicle 100. In this example, the front wheels 104A are coupled to a front axle 108A of the vehicle 100, and the rear vehicle wheels 104B are coupled to a rear axle 108B of the vehicle 100. In this example, the vehicle 100 further includes an example user interface (e.g., a human-machine interface (HMI)) 110, where the user interface 110 can include a display. The vehicle 100 also includes example vehicle sensors 112, where the vehicle sensors 112 can include one or more front cameras 112A, one or more rear cameras 112B, one or more B-pillar sensors and/or one or more B-pillar cameras 112C, and/or one or more example blind spot information system (BLIS) sensors 112D.

In the illustrated example of FIG. 1, the front camera(s) 112A are positioned on and/or coupled to the front portion 106A of the vehicle 100 to capture image(s) of a forward-facing scene (e.g., a projected path) of the vehicle 100. Conversely, the rear camera(s) 112B are positioned on and/or coupled to the rear portion 106B of the vehicle 100 to capture image(s) of a rearward-facing scene with respect to the vehicle 100. In some examples, the vehicle 100 can include one or more additional cameras positioned at respective different location(s) of the vehicle 100 to capture image(s) of the vehicle 100 and/or its surroundings. For example, the additional camera(s) can capture image(s) representative of scene(s) to the side of the vehicle 100, internal to the vehicle 100, etc.

In the illustrated example of FIG. 1, the B-pillar sensor(s) and/or camera(s) 112C are positioned on and/or coupled to a B-pillar 114 of the vehicle 100. In some examples, the B-pillar sensor(s) and/or camera(s) 112C include one or more radar sensors (e.g., B-pillar radar sensors) and/or one or more cameras (e.g., B-pillar cameras). Further, the BLIS sensor(s) 112D can be positioned on and/or coupled to the rear portion 106B of the vehicle 100 and/or to mirrors 116 of the vehicle 100, where the BLIS sensor(s) 112D can include one or more radar sensor(s) (e.g., BLIS radar sensors). In some examples, the B-pillar sensor(s) and/or camera(s) 112C and/or the BLIS sensor(s) 112D can be used to detect and/or determine distance(s) between location(s) of the vehicle 100 and one or more reference locations (e.g., the ground, one or more reference objects, etc.). In some examples, the vehicle 100 can include one or more different sensors (e.g., lidar sensor(s), etc.) in addition to or instead of one(s) of the vehicle sensor(s) 112 described in FIG. 1.

In the illustrated example of FIG. 1, the setup control circuitry 102 can facilitate and/or assist an operator of the vehicle 100 during a trailer setup procedure in which a trailer is coupled to the vehicle 100 (e.g., to the rear portion 106 of the vehicle 100) via a trailer hitch (e.g., a load-distributing trailer hitch). For example, the setup control circuitry 102 is communicatively coupled to the vehicle sensors 112 to obtain, access, and/or receive example sensor data from one(s) of the vehicle sensors 112. Based on the sensor data, the setup control circuitry 102 can generate example setup information to facilitate the trailer setup procedure (e.g., to facilitate adjustment of the load bars and/or chains of the load-distributing hitch). For example, the setup information can indicate, to an operator, whether the rear portion 106B of the vehicle 100 is to be raised or lowered (e.g., via adjustment of the load-distributing hitch) to restore a load on the front wheels 104A of the vehicle 100 (e.g., to shift a portion of the load of the trailer from the rear wheels 104B to the front wheels 104A to achieve a target load restoration for the vehicle 100). In some examples, the setup information can include visual and/or audio instructions indicating how load bar(s) and/or chain(s) of the load-distributing trailer hitch are to be adjusted to achieve the target load restoration.

In this example, the setup control circuitry 102 is communicatively coupled to the user interface 110 to output and/or provide the setup information to the operator. In some examples, the setup control circuitry 102 is further coupled (e.g., operatively coupled) to one or more example indicators 118 positioned on and/or proximate the vehicle 100. In some examples, the indicator(s) 118 can include one or more example light sources, audio sources (e.g., speakers), augmented reality (AR) displays, etc. In some examples, the setup control circuitry 102 can control the indicator(s) to provide additional instruction(s) and/or alert(s) to assist the operator during the trailer setup procedure. In some examples, by providing setup information to an operator to facilitate setup and/or adjustment of a load-distributing hitch, examples disclosed herein can help ensure that a target load restoration for the vehicle 100 is achieved and/or satisfied. As a result, examples disclosed herein can improve steering and/or maneuverability of the vehicle 100 and the trailer.

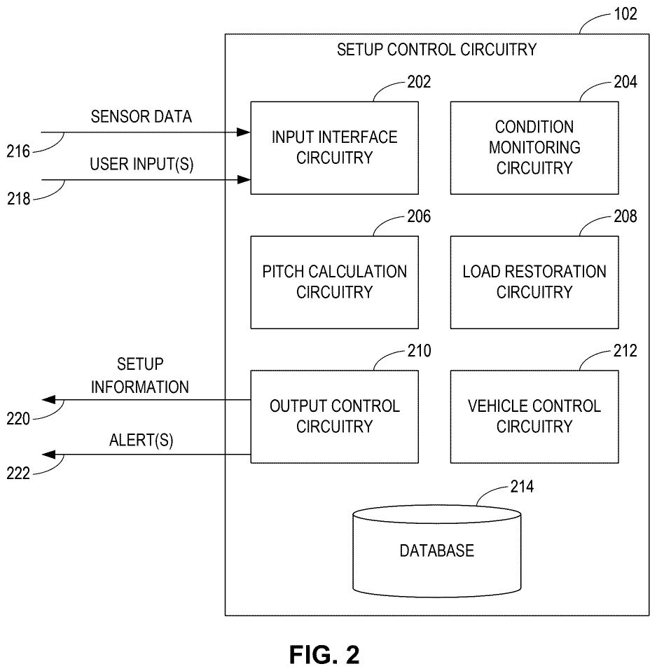

FIG. 2 is a block diagram of an example implementation of the setup control circuitry 102 of FIG. 1. The setup control circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the setup control circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the setup control circuitry 102 includes example input interface circuitry 202, example condition monitoring circuitry 204, example pitch calculation circuitry 206, example load restoration circuitry 208, example output control circuitry 210, example vehicle control circuitry 212, and an example database 214.

The example input interface circuitry 202 of FIG. 2 obtains (e.g., accesses, retrieves) data to be utilized by the setup control circuitry 102 to assist in a trailer setup procedure associated with the vehicle 100 of FIG. 1. For example, the input interface circuitry 202 obtains example sensor data 216 from one(s) of the vehicle sensors 112 of FIG. 1. In some examples, the sensor data 216 includes image data (e.g., first image(s) captured by the front camera(s) 112A and/or second image(s) captured by the rear camera(s) 112B). In some examples, the sensor data 216 can also include image(s) from one or more different cameras (e.g., from a body-worn camera worn by an operator of the vehicle 100, from a camera of a mobile device of the operator, etc.).

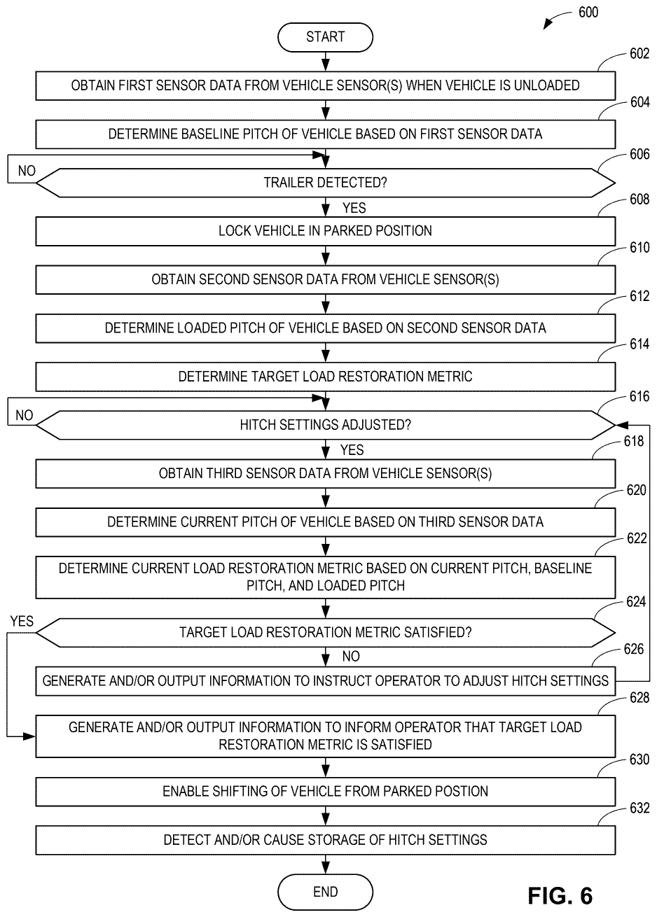

In some examples, the sensor data 216 can include measured distances between one(s) of the vehicle sensors 112 (e.g., the B-pillar sensor(s) and/or camera(s) 112C and/or the BLIS sensor(s) 112D) and one or more reference locations (e.g., reference ground location(s), reference object(s), etc.). In some examples, the setup control circuitry 102 provides the sensor data 216 to the database 214 for storage therein. Additionally, the setup control circuitry 102 can obtain example user input(s) 218 provided by an operator via the user interface 110 of FIG. 1. In some examples, the user input(s) 218 can indicate whether a trailer setup procedure is to be initiated. In some examples, the input interface circuitry 202 is instantiated by programmable circuitry executing input interface circuitry instructions and/or configured to perform operations such as those represented by the flowchart(s) of FIGS. 6 and/or 7.

The example database 214 stores data utilized and/or obtained by the setup control circuitry 102. The example database 214 of FIG. 2 is implemented by any memory, storage device and/or storage disc for storing data such as, for example, flash memory, magnetic media, optical media, solid state memory, hard drive(s), thumb drive(s), etc. Furthermore, the data stored in the example database 214 may be in any data format such as, for example, binary data, comma delimited data, tab delimited data, structured query language (SQL) structures, etc. While, in the illustrated example, the example database 214 is illustrated as a single device, the example database 214 and/or any other data storage devices described herein may be implemented by any number and/or type(s) of memories.

The example condition monitoring circuitry 204 of FIG. 2 monitors, based on the sensor data 216, a condition associated with the vehicle 100 of FIG. 1. For example, the condition monitoring circuitry 204 can monitor the second image(s) from the rear camera(s) 112B to detect whether a trailer is positioned proximate the rear portion 106B of the vehicle 100. In some examples, when the condition monitoring circuitry 204 detects the trailer in the second image(s), the condition monitoring circuitry 204 determines that a trailer setup procedure is to be initiated. In some such examples, the condition monitoring circuitry 204 determines, based on the second image(s), a distance between the trailer and the vehicle 100, and determines that the trailer setup procedure is to be initiated when the distance between the trailer and the vehicle 100 is less than a threshold distance. Additionally or alternatively, the condition monitoring circuitry 204 determines that the trailer setup procedure is to be initiated based on the user input(s) 218 obtained by the input interface circuitry 202.

Further, in some examples, the condition monitoring circuitry 204 continues to monitor a condition of the vehicle 100 and/or the trailer after installation of the trailer on the vehicle 100 and/or during operation of the vehicle 100 and the trailer. For example, the condition monitoring circuitry 204 can monitor the sensor data 216 during travel and/or operation of the vehicle 100 to detect whether a vehicle condition has occurred. For example, the condition monitoring circuitry 204 detects a vehicle condition when the condition monitoring circuitry 204 detects, based on the sensor data 216, sway of the trailer with respect to the vehicle 100. For example, the condition monitoring circuitry 204 detects relative motion of the trailer with respect to the vehicle 100 based on the second image(s) from the rear camera(s) 112B and/or based on data from the B-pillar sensor(s) and/or camera(s) 112C and/or the BLIS sensor(s) 112D. In some examples, the condition monitoring circuitry 204 detects trailer sway when the relative motion between the vehicle 100 and the trailer exceeds a threshold (e.g., a threshold yaw angle and/or a threshold yaw angle rate).

In some examples, the condition monitoring circuitry 204 detects, based on the sensor data 216, a load change condition (e.g., whether a payload on the trailer has increased, decreased, and/or otherwise changed). For example, the condition monitoring circuitry 204 detects whether a payload has been added to and/or removed from the trailer based on image(s) from the rear camera(s) 112B and/or based on data from the B-pillar sensor(s) and/or camera(s) 112C and/or the BLIS sensor(s) 112D. In some examples, the condition monitoring circuitry 204 detects, based on the sensor data 216, whether a stopping condition has occurred (e.g., whether the vehicle 100 and the trailer have come to a stop and/or are otherwise stationary). In some examples, the condition monitoring circuitry 204 is instantiated by programmable circuitry executing condition monitoring circuitry instructions and/or configured to perform operations such as those represented by the flowchart(s) of FIGS. 6 and/or 7.

The example pitch calculation circuitry 206 determines (e.g., estimates) a pitch of the vehicle 100 prior to, during, and/or after installation of a trailer on the vehicle 100. For example, returning to FIG. 1, the vehicle 100 is shown prior to installation of a trailer on the vehicle 100 (e.g., prior to coupling of a trailer to the rear portion 106B of the vehicle 100 via a load-distributing hitch). In some examples, the pitch calculation circuitry 206 determines example baseline heights (e.g., unloaded heights, baseline distances to ground) 120A, 120B, 120C corresponding to respective different locations (e.g., first, second, and third example locations 122A, 122B, 122C) of the vehicle 100. For example, the baseline heights 120A, 120B, 120C correspond to the heights of the respective locations when the vehicle 100 is unloaded (e.g., when no trailer is coupled to the vehicle 100).

In this example, the first location 122A corresponds to the front portion 106A of the vehicle 100 (e.g., a location of the front camera(s) 112A), the second location 122B corresponds to the B-pillar 114 of the vehicle 100 (e.g., a location of the B-pillar sensor(s) and/or camera(s) 112C), and the third location 122C corresponds to the rear portion 106B of the vehicle 100 (e.g., a location of the rear camera(s) 112B and/or the BLIS sensor(s) 112D). While three baseline heights 120A, 120B, 120C are used in this example, only two of the baseline heights 120A, 120B, 120C may be used in some examples. Additionally, the setup control circuitry 102 can determine baseline heights at one or more different locations of the vehicle 100 (e.g., in addition to or instead of one(s) of the first, second, and third locations 122A, 122B, 122C shown in FIG. 1).

In some examples, the pitch calculation circuitry 206 determines the baseline heights 120A, 120B, 120C based on a first portion of the sensor data 216 (e.g., first sensor data) captured by the vehicle sensors 112 at a first time (e.g., prior to loading of the vehicle 100). For example, the pitch calculation circuitry 206 estimates distances to the ground and/or to one or more reference features based on the sensor data 216 to determine the baseline heights 120A, 120B, 120C. Further, based on the baseline heights 120A, 120B, 120C, the pitch calculation circuitry 206 determines a baseline pitch (e.g., an unloaded pitch, a starting pitch) of the vehicle 100 (e.g., a pitch of the vehicle 100 when the vehicle 100 is unloaded and/or when no trailer is coupled to the vehicle 100). For example, the pitch calculation circuitry 206 can determine the baseline pitch based on the baseline heights 120A, 120B, 120C and known relative distances between the first, second, and third locations 122A, 122B, 122C. In some examples, the pitch calculation circuitry 206 provides the baseline heights 120A, 120B, 120C and/or the baseline pitch to the database 214 for storage therein.

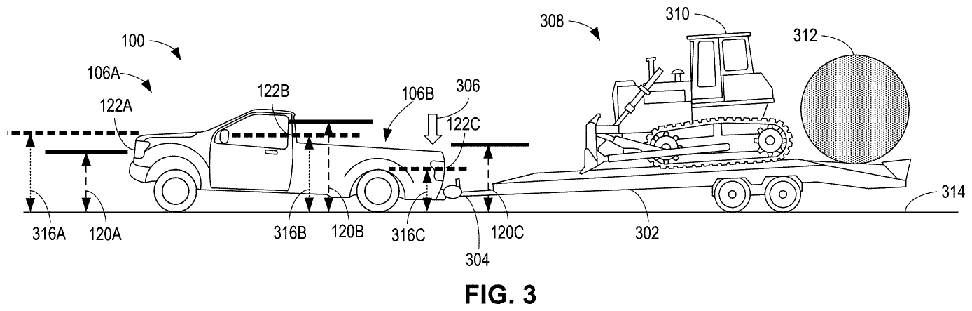

In some examples, after installation of the trailer on the vehicle 100 (e.g., after coupling of the trailer to the vehicle 100 using a load-distributing hitch), the pitch calculation circuitry 206 can determine a loaded pitch (e.g., a maximum pitch, a threshold pitch) of the vehicle 100. For example, FIG. 3 illustrates the example vehicle 100 of FIG. 1 after an example trailer 302 is coupled to the vehicle 100 (e.g., via an example load-distributing hitch 304), but prior to adjustment of the load-distributing hitch 304. In the illustrated example of FIG. 3, the trailer 302 applies an example load 306 on the rear portion 106B of the vehicle 100, where the load 306 is based on a gross trailer weight of the trailer 302 (e.g., a trailer weight of the trailer 302 and a payload weight of a payload 308 on the trailer 302, where the payload 308 includes a tractor 310 and a hay bale 312 in this example). As a result of the load 306 on the vehicle 100, the rear portion 106B of the vehicle 100 may move and/or pivot downward in FIG. 3 (e.g., toward a ground surface 314) and the front portion 106A of the vehicle 100 may move and/or pivot upward in FIG. 3 (e.g., away from the ground surface 314).

In this example, the pitch calculation circuitry 206 of FIG. 2 can determine example loaded heights (e.g., threshold heights) 316A, 316B, 316C of the respective locations 122A, 122B, 122C of the vehicle 100. For example, the loaded heights 316A, 316B, 316C correspond to new heights of the respective locations 122A, 122B, 122C after the trailer 302 is coupled to the vehicle 100, but prior to adjustment of the load-distributing hitch 304. In the illustrated example of FIG. 3, the pitch calculation circuitry 206 obtains new sensor data 216 from one(s) the vehicle sensors 112 of FIG. 1, and determines the loaded heights 316A, 316B, 316C based on the new sensor data 216. Further, in some examples, the pitch calculation circuitry 206 can determine a loaded pitch of the vehicle 100 (e.g., a pitch of the vehicle 100 when the trailer 302 is coupled to the vehicle 100) based on the loaded heights 316A, 316B, 316C. In some examples, the pitch calculation circuitry 206 can determine a change in vehicle pitch (e.g., from the baseline pitch shown in FIG. 1 to the loaded pitch shown in FIG. 3) based on differences between the baseline heights 120A, 120B, 120C and the corresponding loaded heights 316A, 316B, 316C for the respective locations 122A, 122B, 122C.

In some examples, the pitch calculation circuitry 206 determines the loaded pitch based on image data captured by the front camera(s) 112A and/or the rear camera(s) 112B of FIG. 1. For example, the pitch calculation circuitry 206 can obtain first image(s) captured at a first time (e.g., when the vehicle 100 is unloaded as shown in FIG. 1) and second image(s) captured at a second time (e.g., when the vehicle 100 is loaded as shown in FIG. 2), and estimates distances to known reference locations (e.g., reference points, reference objects) represented in the first and second images. For example, the pitch calculation circuitry 206 can estimate the distance(s) to the known reference object(s) based on a comparison between known dimension(s) of the reference object(s) (e.g., as input by an operator via the user interface 110) and measured dimension(s) of the reference object(s) in the first and second images. In some examples, based the changes in distance to the reference object(s) between the first and second images, the pitch calculation circuitry 206 can estimate a change in the heights at the respective locations 122A, 122B, 122C and, thus, can estimate a change in the vehicle pitch from when the vehicle 100 is unloaded (FIG. 1) to when the vehicle 100 is loaded (FIG. 3). In some examples, the pitch calculation circuitry 206 provides the loaded heights 316A, 316B, 316C and/or the loaded pitch to the database 214 for storage therein.

In some examples, the pitch calculation circuitry 206 continuously and/or periodically determines the pitch of the vehicle 100 during and/or after adjustment of the load-distributing hitch 304, and/or during travel and/or operation of the vehicle 100 and the trailer 302. For example, the pitch calculation circuitry 206 continuously and/or periodically obtains new sensor data 216 (e.g., via the input interface circuitry 202 of FIG. 2), and determines, based on the new sensor data 216, current heights of the respective locations 122A, 122B, 122C. In such examples, the pitch calculation circuitry 206 determines a current pitch of the vehicle 100 based on the current heights, where the current pitch can be used to instruct an operator during a trailer setup procedure and/or inform the operator whether a target load restoration of the vehicle 100 is satisfied. In some examples, the pitch calculation circuitry 206 is instantiated by programmable circuitry executing pitch calculation circuitry instructions and/or configured to perform operations such as those represented by the flowchart(s) of FIGS. 6 and/or 7.

Returning to FIG. 2, the example load restoration circuitry 208 estimates, monitors, and/or facilitates adjustment of load restoration to the front wheels 104A of the vehicle 100. For example, the load restoration circuitry 208 can monitor the load restoration during and/or after adjustment of the load-distributing hitch 304 that couples the trailer 302 to the vehicle 100.

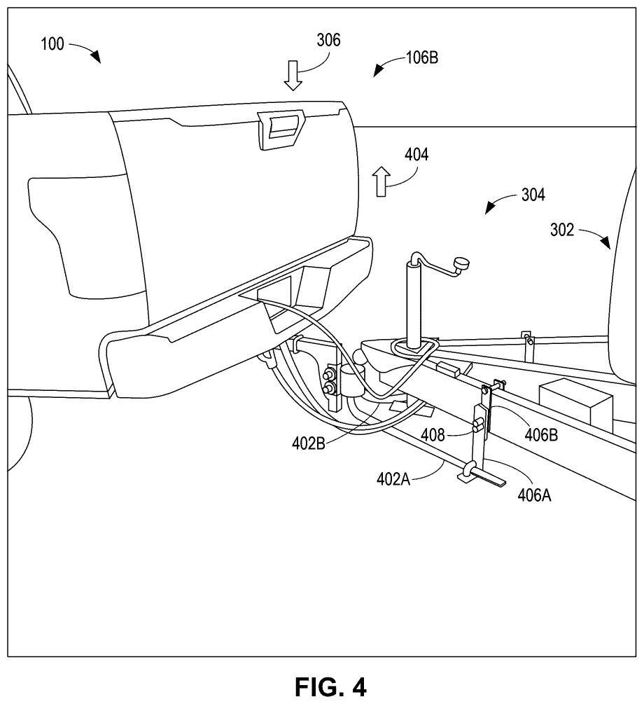

Turning to FIG. 4, a detailed view of the load-distributing hitch 304 of FIG. 3 is shown coupled to the rear portion 106B of the vehicle 100. In the illustrated example of FIG. 4, the load-distributing hitch 304 includes example load bars 402A, 402B that can be used to provide and/or adjust an upward force (e.g., a counteracting force) 404 on the rear portion 106B to counteract and/or oppose the load 306 from the trailer 302 of FIG. 3. For example, the upward force 404 can be used to lift the rear portion 106B of the vehicle 100 and, as a result, to shift a portion of the load 306 from the rear portion 106B (e.g., from the rear wheels 104B of FIG. 1) to the front portion 106A and/or the front wheels 104A of FIG. 1. In some examples, shifting of the load 306 from the rear wheels 104B to the front wheels 104A results in load restoration to the front wheels 104A.

In some examples, a magnitude of the upward force 404 can be adjusted by adjusting position(s) of the load bar(s) 402A, 402B. For example, as shown in FIG. 4, the first load bar 402A is coupled to the trailer 302 via example bars (e.g., rigid bars) 406A, 406B. In some examples, relative position of the bars 406A, 406B can be adjusted to adjust the position of the first load bar 402A (e.g., an angle of the first load bar 402A with respect to the ground). In some examples, example fasteners (e.g., pins, bolts, etc.) 408 can be positioned in corresponding openings of the bars 406A, 406B to maintain the relative positions of the bars 406A, 406B and, thus, maintain and/or hold the position of the first load bar 402A (e.g., with respect to the ground).

While the bars 406A, 406B are used in this example, one or more chains (e.g., tensioning chains) can be used to couple the load bar(s) 402A, 402B to the trailer 302 instead. For example, the chain(s) can be coupled between the load bar(s) 402A, 402B and the trailer 302, and a length of the chain(s) can be adjusted to adjust a tension in the chain(s) and, as a result, adjust the position(s) of the load bar(s) 402A, 402B. In some examples, the tension in the chain(s) can be increased (e.g., by reducing an effective length of the chain(s)) to pull the load bar(s) 402A, 402B upward with respect to the ground, and the tension in the chain(s) can be reduced (e.g., by increasing the effective length of the chain(s)) to release the load bar(s) 402A, 402B downward toward the ground. In some examples, the effective length of the chain(s) can be measured based on the length of the chain(s) extending between the load bar(s) 402A, 402B and corresponding attachment point(s) on the trailer 302, and/or based on a number of chain links of the chain(s) between the load bar(s) 402A, 402B and the corresponding attachment point(s).

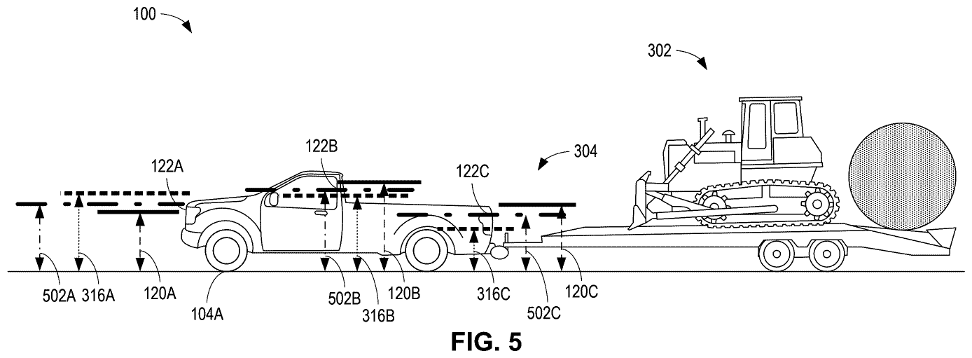

In some examples, during and/or after adjustment of the load-distributing hitch 304 (e.g., by an operator), the load restoration circuitry 208 estimates a current load restoration (e.g., a load restoration metric) associated with the vehicle 100. For example, FIG. 5 illustrates the example vehicle 100 of FIGS. 1, 3, and/or 4 during and/or after adjustment of the load-distributing hitch 304 (e.g., during and/or after adjustment of the position(s) of the load bar(s) 402A, 402B of FIG. 4). In the illustrated example of FIG. 5, as a result of the adjustment of the load-distributing hitch 304, the first, second, and third locations 122A, 122B, 122C of the vehicle 100 are at first, second, and third adjusted heights 502A, 502B, 502C, respectively. In this example, the adjusted heights 502A, 502B, 502C are between respective ones of baseline heights 120A, 120B, 120C and the loaded heights 316A, 316B, 316C). In some examples, the pitch calculation circuitry 206 of FIG. 2 determines the adjusted heights 502A, 502B, 502C based on the sensor data 216 of FIG. 2, and determines a current pitch (e.g., an adjusted pitch) of the vehicle 100 based on the adjusted heights 502A, 502B, 502C.

In some examples, the load restoration circuitry 208 determines a current load restoration (e.g., a current load restoration metric) of the vehicle 100 based on the current pitch (shown in FIG. 5) relative to the baseline pitch (shown in FIG. 1) and the loaded pitch (shown in FIG. 3). For example, the load restoration circuitry 208 can estimate the current load restoration based on a first difference between the baseline pitch and the loaded pitch, and a second difference between the current pitch and the loaded pitch. In some examples, the current load restoration corresponds to a ratio of the second difference relative to the first difference (e.g., the second difference divided by the first difference). For example, the current load restoration is approximately 0 percent (%) when the current pitch is substantially equal to the loaded pitch (e.g., when the adjusted heights 502A, 502B, 502C are substantially equal to the loaded heights 316A, 316B, 316C), and the current load restoration is approximately 100% when the current pitch is substantially equal to the baseline pitch (e.g., when the adjusted heights 502A, 502B, 502C are substantially equal to the baseline heights 120A, 120B, 120C). In some examples, the current load restoration is approximately 50% when the current pitch is approximately halfway between the loaded pitch and the baseline pitch.

In some examples, the load restoration circuitry 208 determines whether the current load restoration satisfies a target load restoration (e.g., a threshold load restoration) for the vehicle 100. In some examples, the target load restoration can be selected by an operator and provided to the setup control circuitry 102 via the user input(s) 218 of FIG. 2. In some examples, the target load restoration is preloaded in the setup control circuitry 102. In some examples, the target load restoration is based on a vehicle type and/or model of the vehicle 100, and/or is based on a manufacturer recommendation for the vehicle 100. In some examples, the target load restoration is approximately 50 percent (%). In some examples, the target load restoration may be different (e.g., less than or greater than 50%).

In some examples, the load restoration circuitry 208 determines that the target load restoration is satisfied when the current load restoration is greater than or equal to the target load restoration and, conversely, the load restoration circuitry 208 determines that the target load restoration is not satisfied when the current load restoration is less than the target load restoration. In some examples, when the load restoration circuitry 208 determines that the target load restoration is not satisfied, the load restoration circuitry 208 determines a difference between the target load restoration and the current load restoration. In some examples, the load restoration circuitry 208 determines that a trailer setup procedure is complete when the target load restoration is satisfied.

In some examples, when the load restoration circuitry 208 determines that the target load restoration is satisfied, the load restoration circuitry 208 obtains and/or records current hitch settings (e.g., current load bar and/or chain settings) of the load-distributing hitch 304. For example, the load restoration circuitry 208 can utilize a portion of the sensor data 216 (e.g., image(s) captured by the rear camera(s) 112B of the vehicle 100) to detect and/or identify the current hitch settings of the load-distributing hitch 304. In some examples, the current settings can include load bar settings (e.g., position(s) of the load bar(s) 402A, 402B of FIG. 1) and/or chain settings (e.g., effective length(s) of chain(s) of the load-distributing hitch 304). In some examples, the load restoration circuitry 208 causes storage of the current hitch settings as example historical data (e.g., reference data) in the database 214 of FIG. 2.

In some examples, the load restoration circuitry 208 determines and/or estimates the current load restoration of the vehicle 100 after the trailer setup procedure is complete. For example, when the condition monitoring circuitry 204 detects a vehicle condition during travel and/or operation of the vehicle 100 (e.g., a trailer sway condition, a load change condition, a stopping condition, etc.), the condition monitoring circuitry 204 triggers and/or invokes the load restoration circuitry 208 to determine the current load restoration and/or to determine whether the current load restoration satisfies the target load restoration. In some examples, the load restoration circuitry 208 is instantiated by programmable circuitry executing load restoration circuitry instructions and/or configured to perform operations such as those represented by the flowchart(s) of FIGS. 6 and/or 7.

Returning to FIG. 2, the example output control circuitry 210 generates and/or outputs example setup information 220 to facilitate adjustment of the load-distributing hitch 304 of FIGS. 3, 4, and/or 5 during a trailer setup procedure. For example, the output control circuitry 210 can output the setup information 220 via the user interface 110 of FIG. 1, via one or more of the indicators 118 of FIG. 1, via one or more mobile devices, etc. In some examples, the setup information 220 can include visual and/or audio information. In some examples, during a trailer setup procedure, the output control circuitry 210 can output the setup information 220 including safety reminder(s) at one or more stages of the trailer setup procedure (e.g., prior to release of tension in the load bars 402A, 402B and/or the chain(s)). In some examples, the output control circuitry 210 can monitor (e.g., based on the sensor data 216) a position of an operator relative to one or more components of the vehicle 100 and/or the trailer 302, and can inform the operator, via the setup information 220, when the operator is proximate to (e.g., within a threshold distance from) component(s) that are storing energy (e.g., electrical energy, etc.).

In some examples, the setup information 220 can include the current load restoration and/or the target load restoration determined for the vehicle 100 (e.g., by the load restoration circuitry 208). For example, the setup information 220 can include an indication of whether the target load restoration is satisfied, and/or can include instructions to increase (or decrease) the current load restoration. In some examples, when the load restoration circuitry 208 determines that the current load restoration is less than (e.g., does not satisfy) the target load restoration (e.g., the current pitch of the vehicle 100 is greater than a target pitch corresponding to the target load restoration), the output control circuitry 210 generates the setup information 220 to include instructions to an operator to adjust position(s) of the load bars 402A, 402B of the load-distributing hitch 304. In some such examples, the setup information 220 can instruct the operator to increase tension in the load bars 402A, 402B and/or in chain(s) of the load-distributing hitch 304 to increase an upward force on the rear portion 106B of the vehicle 100 and, as a result, to reduce the current pitch (e.g., increase the current load restoration) of the vehicle 100. Conversely, in some examples, the setup information 220 can instruct the operator to reduce tension in the load bars 402A, 402B and/or in the chain(s) of the load-distributing hitch 304 to increase the current pitch (e.g., reduce the current load restoration) of the vehicle 100.

In some examples, the output control circuitry 210 can generate the setup information 220 based on historical data associated with the load-distributing trailer hitch. For example, the output control circuitry 210 can instruct the operator, via the setup information 220, to adjust the load bar(s) 402A, 402B and/or the chain(s) of the load-distributing hitch 304 to substantially match (e.g., correspond to) the hitch settings (e.g., the load bar settings and/or chain settings) previously stored as historical data in the database 214 (e.g., when the target load restoration was previously satisfied). Additionally or alternatively, the output control circuitry 210 can generate the setup information 220 based on execution of one or more machine learning models. For example, the machine learning model(s) can be trained, based on the historical data for the vehicle 100 and/or for one or more other vehicles, to output target hitch settings (e.g., starting hitch settings) when the machine learning model(s) are executed based on example input data associated with the vehicle 100 and/or the trailer 302.

In some examples, the input data provided to the machine learning model(s) can include a type of the vehicle 100 and/or the trailer 302, a type and/or size of a payload on the trailer 302, a hitch type of the load distributing hitch 304, etc. In some examples, the input data can be preloaded in the database 214, provided via the user input(s) 218, and/or detected via the sensor data 216. In some examples, as a result of execution of the machine learning model(s) based on the input data, the machine learning model(s) output starting hitch settings for the load distributing hitch 304. For example, the starting hitch settings can include starting chain settings (e.g., effective length(s) of chain(s) of the load distributing hitch 304) expected to result in the target load restoration for the vehicle 100. In some examples, by determining the starting hitch settings using the machine learning model(s), the hitch settings may necessitate fewer adjustments to achieve the target load restoration and, thus, the target load restoration may be achieved more quickly (e.g., compared to when the starting hitch settings are manually selected by the operator).

In some examples, the output control circuitry 210 can, in addition to or instead of outputting the setup information 220 via the user interface 110, control the indicator(s) 118 of FIG. 1 to provide the setup information 220 to the operator (e.g., during a trailer setup procedure). For example, the indicators 118 can include one or more light sources, and the output control circuitry 210 can cause illumination of the light source(s) to indicate whether the target load restoration is satisfied and/or whether the current load restoration is to be adjusted (e.g., increased or decreased). In some examples, the output control circuitry 210 can cause illumination of a first light source having a first color (e.g., green) when the target load restoration is satisfied, and can cause illumination of a second light source having a second color (e.g., red) when the target load restoration is not satisfied. In some examples, the output control circuitry 210 can cause one or more taillights and/or one or more headlights of the vehicle 100 to illuminate when the target load restoration is satisfied (or not satisfied).

In some examples, the output control circuitry 210 can control one or more audio sources (e.g., speakers, sound exciters, etc.) included in the indicators 118 to provide the setup information 220 (or a portion thereof). For example, the output control circuitry 210 can cause the audio source(s) to output audio instructions to the operator, where the audio instructions instruct the operator to increase (or decrease) the tension of the load bars and/or otherwise adjust the load-distributing hitch 304. In some examples, the output control circuitry 210 can cause the audio source(s) to output an alarm and/or other sound(s) when the target load restoration is satisfied (or not satisfied). Additionally or alternatively, the output control circuitry 210 can control one or more AR displays of the vehicle 100 and/or of a mobile device of the operator to, for example, identify component(s) of the load-distributing hitch 304 that are to be adjusted and/or to indicate how the component(s) are to be adjusted.

In some examples, the output control circuitry 210 can output one or more example alerts 222 during operation and/or travel of the vehicle 100. In some examples, the alert(s) can include visual alert(s) and/or audio alert(s) output via the user interface 110 and/or one or more of the indicators 118. For example, the output control circuitry 210 can output the alert(s) 222 to inform an operator of the vehicle 100 when a vehicle condition is detected. In some such examples, the alert(s) 222 can instruct the operator to stop and/or pull the vehicle 100 over to a side of the road, to adjust hitch settings of the load-distributing hitch 304, etc. In some such examples, the output control circuitry 210 can communicate the alert(s) 222 to one or more different device(s) (e.g., remote device(s), cloud-based device(s), etc.) communicatively coupled to the setup control circuitry 102. For example, the alert(s) can be provided to a device implementing fleet management software to inform and/or facilitate service and/or maintenance activities for the vehicle 100. In some examples, the output control circuitry 210 is instantiated by programmable circuitry executing output control circuitry instructions and/or configured to perform operations such as those represented by the flowchart(s) of FIGS. 6 and/or 7.

The example vehicle control circuitry 212 can activate and/or control one or more control device(s) of the vehicle 100 based on a detected condition of the vehicle 100. For example, when the condition monitoring circuitry 204 determines that a trailer setup procedure is to be initiated, the vehicle control circuitry 212 can engage brakes of the vehicle 100 and/or otherwise lock the vehicle 100 in a parked position. Conversely, when the load restoration circuitry 208 determines that the target load restoration of the vehicle 100 is satisfied (e.g., the trailer setup procedure is complete), the vehicle control circuitry 212 can unlock and/or enable shifting of the vehicle 100 from the parked position.

In some examples, during the trailer setup procedure, the vehicle control circuitry 212 can control auxiliary lighting (e.g., focused zone lighting) of the vehicle 100 to assist the operator in installing the trailer on the vehicle 100 and/or adjusting the load-distributing trailer hitch. For example, the auxiliary lighting can include one or more auxiliary light sources coupled to and/or proximate the rear portion 106 of the vehicle 100, the trailer, and/or the load-distributing trailer hitch. In some examples, the vehicle control circuitry 212 can illuminate one(s) of the auxiliary light sources and/or adjust position(s) and/or orientation(s) of the auxiliary light source(s) to indicate (e.g., point to) component(s) of the load-distributing hitch 304 that are to be adjusted. In some examples, the vehicle control circuitry 212 can illuminate the auxiliary light source(s) in response to detecting, based on the sensor data 216, that the operator is within a threshold distance (e.g., 5 feet, 3 feet, etc.) of the load-distributing hitch 304. In some examples, the vehicle control circuitry 212 can monitor a position and/or location of the operator based on the sensor data 216, and can adjust the position(s) and/or orientation(s) of the auxiliary light source(s) to follow the operator (e.g., to illuminate an area proximate to and/or surrounding the operator).

In some examples, after the trailer setup procedure is complete and/or during operation of the vehicle 100 and the trailer, the vehicle control circuitry 212 can activate one or more of the control devices when the condition monitoring circuitry 204 detects a vehicle condition (e.g., a trailer sway condition, load change condition, a stopping condition, etc.). For example, when a vehicle condition is detected during travel of the vehicle 100, the vehicle control circuitry 212 can restrict and/or limit a speed of the vehicle 100 (e.g., prevent the vehicle 100 from travelling at a speed greater than a threshold speed). In some examples, the vehicle control circuitry 212 can maintain the restriction and/or limitation on the speed of the vehicle 100 until the condition monitoring circuitry 204 no longer detects the vehicle condition, the load restoration circuitry 208 determines that a target load restoration is satisfied, and/or an operator bypasses and/or manually overrides the restriction (e.g., via the user input(s) 218 to the user interface 110). In some examples, the vehicle control circuitry 212 is instantiated by programmable circuitry executing vehicle control circuitry instructions and/or configured to perform operations such as those represented by the flowchart(s) of FIGS. 6 and/or 7.

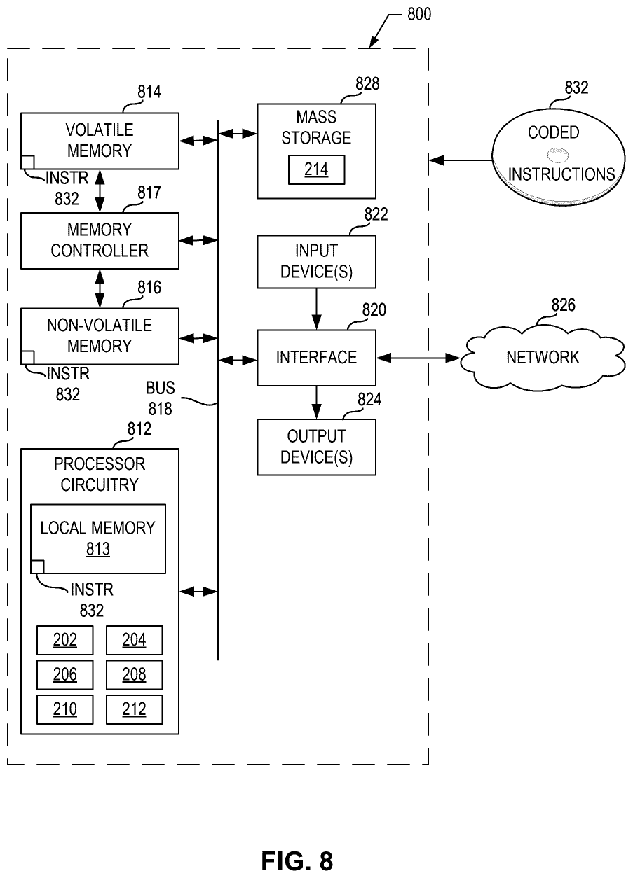

In some examples, the setup control circuitry 102 includes means for obtaining data, means for monitoring, means for calculating pitch, means for determining load restoration, means for outputting, and means for controlling. For example, the means for obtaining data may be implemented by the input interface circuitry 202, the means for monitoring may be implemented by the condition monitoring circuitry 204, the means for calculating pitch may be implemented by the pitch calculation circuitry 206, the means for determining load restoration may be implemented by the load restoration circuitry 208, the means for outputting may be implemented by the output control circuitry 210, and the means for controlling may be implemented by the vehicle control circuitry 212. In some examples, the input interface circuitry 202, the condition monitoring circuitry 204, the pitch calculation circuitry 206, the load restoration circuitry 208, the output control circuitry 210, and/or the vehicle control circuitry 212 may be instantiated by programmable circuitry such as the example programmable circuitry 812 of FIG. 8. In some examples, input interface circuitry 202, the condition monitoring circuitry 204, the pitch calculation circuitry 206, the load restoration circuitry 208, the output control circuitry 210, and/or the vehicle control circuitry 212 may be instantiated by hardware logic circuitry, which may be implemented by an ASIC, XPU, or FPGA circuitry configured and/or structured to perform operations corresponding to machine readable instructions. Additionally or alternatively, the input interface circuitry 202, the condition monitoring circuitry 204, the pitch calculation circuitry 206, the load restoration circuitry 208, the output control circuitry 210, and/or the vehicle control circuitry 212 may be instantiated by any other combination of hardware, software, and/or firmware. For example, the input interface circuitry 202, the condition monitoring circuitry 204, the pitch calculation circuitry 206, the load restoration circuitry 208, the output control circuitry 210, and/or the vehicle control circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the setup control circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the input interface circuitry 202, the condition monitoring circuitry 204, the pitch calculation circuitry 206, the load restoration circuitry 208, the output control circuitry 210, the vehicle control circuitry 212, the database 214, and/or, more generally, the example setup control circuitry 102 of FIG. 2, may be implemented by hardware alone or by hardware in combination with software and/or firmware. Thus, for example, any of the input interface circuitry 202, the condition monitoring circuitry 204, the pitch calculation circuitry 206, the load restoration circuitry 208, the output control circuitry 210, the vehicle control circuitry 212, the database 214, and/or, more generally, the example setup control circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example setup control circuitry 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the setup control circuitry 102 of FIG. 2 and/or representative of example operations which may be performed by programmable circuitry to implement and/or instantiate the setup control circuitry 102 of FIG. 2, are shown in FIGS. 6 and/or 7. The machine readable instructions may be one or more executable programs or portion(s) of one or more executable programs for execution by programmable circuitry such as the programmable circuitry 812 shown in the example processor platform 800 discussed below in connection with FIG. 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6 and/or 7, many other methods of implementing the example setup control circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6 and/or 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to implement the setup control circuitry 102 of FIGS. 1 and 2 to facilitate an example trailer setup procedure. The example machine-readable instructions and/or the example operations 600 of FIG. 6 begin at block 602, at which the setup control circuitry 102 obtains first sensor data from the vehicle sensor(s) 112 of FIG. 1 when the vehicle 100 of FIG. 1 is unloaded (e.g., prior to coupling of the trailer 302 of FIG. 3 to the vehicle 100). For example, the example input interface circuitry 202 of FIG. 2 obtains the first sensor data from the vehicle sensor(s) 112, where the first sensor data corresponds to the sensor data 216 (or a portion thereof) captured by the vehicle sensor(s) 112 at a first time (e.g., when the vehicle 100 is unloaded). In some examples, the first sensor data can include image(s) captured by the front camera(s) 112A and/or the rear camera(s) 112B, distance(s) to one or more reference points measured by the B-pillar sensor(s) and/or camera(s) 112C and/or the BLIS sensor(s) 112D, etc.

At block 604, the setup control circuitry 102 determines a baseline pitch of the vehicle 100 based on the first sensor data. For example, the example pitch calculation circuitry 206 of FIG. 2 determines baseline heights (e.g., the baseline heights 120A, 120B, 120C of FIG. 1) of the vehicle 100 based on the first sensor data, and determines the baseline pitch of the vehicle 100 based on the baseline heights. In some examples, the baseline pitch corresponds to a pitch angle of the vehicle 100 (e.g., relative to the ground surface 314) when the vehicle 100 is unloaded (e.g., when the trailer 302 is not coupled to the vehicle 100).

At block 606, the setup control circuitry 102 detects whether a trailer (e.g., the trailer 302) is coupled to and/or proximate to the vehicle 100. For example, the example condition monitoring circuitry 204 of FIG. 2 detects, based on the sensor data 216, whether the trailer 302 is coupled to the vehicle 100 (e.g., via the load-distributing hitch 304). In some examples, the condition monitoring circuitry 204 determines that a trailer setup procedure is to be initiated when the trailer 302 is coupled to the vehicle 100. In some examples, in response to the condition monitoring circuitry 204 not detecting the trailer 302 (e.g., block 606 returns a result of NO), control remains at block 606 (e.g., until the trailer 302 is detected). Alternatively, in response to the condition monitoring circuitry 204 detecting the trailer 302 (e.g., block 606 returns a result of YES), control proceeds to block 608.

At block 608, the setup control circuitry 102 locks the vehicle 100 in a parked position. For example, the example vehicle control circuitry 212 locks the vehicle 100 in a parked position and/or otherwise prevents travel of the vehicle 100.

At block 610, the setup control circuitry 102 obtains second sensor data from the vehicle sensor(s) 112. For example, the input interface circuitry 202 obtains the second sensor data from the vehicle sensor(s) 112 when the vehicle 100 is loaded (e.g., when the trailer 302 is coupled to the vehicle 100, but prior to adjustment of the load bar(s) 402A, 402B of the load-distributing hitch 304). In some examples, the second sensor data corresponds to the sensor data 216 (or a portion thereof) captured by the vehicle sensor(s) 112 at a second time (e.g., when the vehicle 100 is loaded).

At block 612, the setup control circuitry 102 determines a loaded pitch of the vehicle 100 based on the second sensor data. For example, the pitch calculation circuitry 206 determines loaded heights (e.g., the loaded heights 316A, 316B, 316C of FIG. 3) of the vehicle 100 based on the second sensor data, and determines the loaded pitch of the vehicle 100 based on the loaded heights. In some examples, the loaded pitch corresponds to a pitch angle of the vehicle 100 (e.g., relative to the ground surface 314) when the vehicle 100 is loaded (e.g., when the trailer 302 is coupled to the vehicle 100, but prior to adjustment of the load bars 402A, 402B of the load-distributing hitch 304).

At block 614, the setup control circuitry 102 determines a target load restoration metric for the vehicle 100. For example, the example load restoration circuitry 208 determines the target load restoration metric based on a vehicle type and/or model of the vehicle 100, and/or based on a manufacturer recommendation for the vehicle 100. In some examples, the load restoration circuitry 208 determines a target pitch corresponding to the target load restoration metric. For example, for a target load restoration metric of 50%, the load restoration circuitry 208 can determine that the target pitch is approximately halfway between the baseline pitch and the loaded pitch of the vehicle 100.

At block 616, the setup control circuitry 102 determines whether hitch settings of the load-distributing hitch 304 have been adjusted. For example, the condition monitoring circuitry 204 monitors the sensor data 216 to determine whether the hitch settings (e.g., position(s) of the load bar(s) 402A, 402B, length(s) of chain(s) of the load-distributing hitch 304, etc.) have been adjusted. In response to the condition monitoring circuitry 204 determining that the hitch settings have not been adjusted (e.g., block 616 returns a result of NO), control remains at block 616 until the condition monitoring circuitry 204 determines that the hitch settings have been adjusted. In response to the condition monitoring circuitry 204 determining that the hitch settings have been adjusted (e.g., block 616 returns a result of YES), control proceeds to block 618.

At block 618, the setup control circuitry 102 obtains third sensor data from the vehicle sensor(s) 112. For example, the input interface circuitry 202 obtains the third sensor data from the vehicle sensor(s) 112 when the trailer 302 is coupled to the vehicle 100 and after adjustment of the hitch settings of the load-distributing hitch 304. In some examples, the third sensor data corresponds to the sensor data 216 (or a portion thereof) captured by the vehicle sensor(s) 112 at a third time (e.g., after adjustment of the hitch settings, after the first time and the second time).

At block 620, the setup control circuitry 102 determines a current pitch of the vehicle 100 based on the third sensor data. For example, the pitch calculation circuitry 206 determines current heights (e.g., the adjusted heights 502A, 502B, 502C of FIG. 5) of the vehicle 100 based on the third sensor data, and determines the current pitch of the vehicle 100 based on the current heights. In some examples, the current pitch corresponds to a pitch angle of the vehicle 100 (e.g., relative to the ground surface 314) when the trailer 302 is coupled to the vehicle 100 and the hitch settings of the load-distributing hitch 304 have been adjusted (e.g., relative to starting hitch settings when the vehicle 100 is loaded).

At block 622, the setup control circuitry 102 determines a current load restoration metric based on the current pitch, the baseline pitch, and the loaded pitch. For example, the load restoration circuitry 208 determines the current load restoration metric based on the current pitch relative to the baseline pitch and the loaded pitch (e.g., based on a ratio between a first difference between the current pitch and the loaded pitch, and a second difference between the baseline pitch and the loaded pitch).

At block 624, the setup control circuitry 102 determines whether the target load restoration metric is satisfied. For example, the load restoration circuitry 208 determines that the target load restoration metric is satisfied when the current load restoration metric is greater than or equal to the target load restoration metric. In some examples, the load restoration circuitry 208 determines that the target load restoration metric is satisfied when a difference between the target load restoration metric and the current load restoration metric is less than a threshold (e.g., 1%, 5%, etc.). In response to the load restoration circuitry 208 determining that the target load restoration metric is satisfied (e.g., block 624 returns a result of YES), control proceeds to block 628. Alternatively, in response to the load restoration circuitry 208 determining that the target load restoration metric is not satisfied (e.g., block 624 returns a result of NO), control proceeds to block 626.

At block 626, the setup control circuitry 102 generates and/or outputs information to instruct an operator of the vehicle 100 to adjust the hitch settings of the load-distributing hitch 304. For example, the example output control circuitry 210 of FIG. 2 generates the setup information 220 to include instructions to the operator to adjust position(s) of the load bar(s) 402A, 402B, adjust tension in chain(s) of the load-distributing hitch 304, etc. In such examples, the output control circuitry 210 outputs the setup information 220 via the user interface 110 of FIG. 1, via one or more of the indicators 118 of FIG. 1, etc. In some examples, control returns to block 616.

At block 628, the setup control circuitry 102 generates and/or outputs information to inform the operator of the vehicle 100 that the target load restoration metric is satisfied. For example, the output control circuitry 210 generates the setup information 220 to include an indication that the target load restoration metric is satisfied (e.g., that no further adjustment of the hitch settings is required). In such examples, the output control circuitry 210 outputs the setup information 220 via the user interface 110 of FIG. 1, via one or more of the indicators 118 of FIG. 1, etc.

At block 630, the setup control circuitry 102 enables shifting of the vehicle 100 from the parked position. For example, the vehicle control circuitry 212 unlocks and/or enables shifting of the vehicle 100 from the parked position when the trailer setup procedure is complete (e.g., when the target load restoration metric is satisfied).

At block 632, the setup control circuitry 102 detects and/or causes storage of the hitch settings. For example, the load restoration circuitry 208 detects, based on the third sensor data, the current hitch settings (e.g., position(s) of the load bar(s) 402A, 402B, effective length(s) of chain(s) of the load-distributing hitch 304, etc.), and causes storage of the detected hitch settings (e.g., as historical data) in the database 214 of FIG. 2.

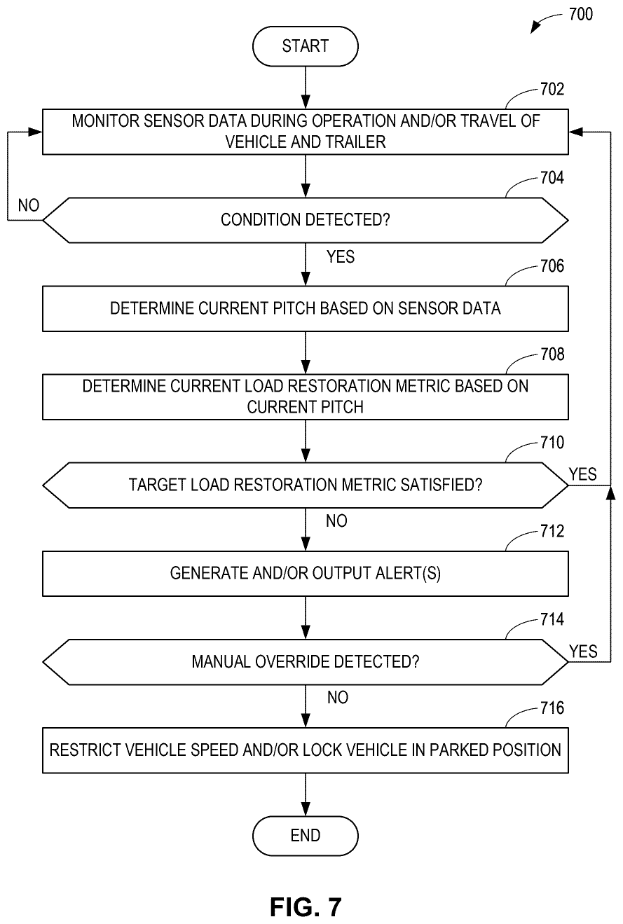

FIG. 7 is a flowchart representative of example machine readable instructions and/or example operations 700 that may be executed, instantiated, and/or performed by programmable circuitry to implement the example setup control circuitry 102 of FIGS. 1 and 2 to monitor load restoration of the vehicle 100 during operation and/or travel. The example machine-readable instructions and/or the example operations 700 of FIG. 7 begin at block 702, at which the setup control circuitry 102 monitors example sensor data (e.g., the sensor data 216 of FIG. 2) during operation and/or travel of the vehicle 100 and the trailer 302. For example, the example input interface circuitry 202 of FIG. 2 obtains and/or monitors the sensor data 216 from one or more of the vehicle sensor(s) 112 of FIG. 1 during operation and/or travel of the vehicle 100 and the trailer 302.

At block 704, the setup control circuitry 102 determines whether a condition associated with the vehicle 100 is detected. For example, the example condition monitoring circuitry 204 of FIG. 2 monitors the sensor data 216 to detect whether a condition has occurred. In some examples, the condition monitoring circuitry 204 can detect a stopping condition (e.g., when the vehicle 100 and the trailer 302 have slowed to a stop and/or are otherwise stationary), a trailer sway condition (e.g., when relative motion between the vehicle 100 and the trailer 302 exceeds a threshold), and/or a load change condition (e.g., when the payload 308 on the trailer 302 has increased, decreased, and/or otherwise changed). In response to the condition monitoring circuitry 204 not detecting a condition (e.g., block 704 returns a result of NO), control remains at block 704 until a condition is detected. Alternatively, in response to the condition monitoring circuitry 204 detecting a condition (e.g., block 704 returns a result of YES), control proceeds to block 706.

At block 706, the setup control circuitry 102 determines a current pitch of the vehicle 100 based on the sensor data 216. For example, the example pitch calculation circuitry 206 of FIG. 2 determines current heights (e.g., the adjusted heights 502A, 502B, 502C of FIG. 5) of the vehicle 100 based on the sensor data 216, and determines the current pitch of the vehicle 100 based on the current heights.

At block 708, the setup control circuitry 102 determines a current load restoration metric based on the current pitch. For example, the example load restoration circuitry 208 of FIG. 2 determines the current load restoration metric based on a ratio between a first difference between the current pitch and a loaded pitch of the vehicle 100, and a second difference between a baseline pitch of the vehicle 100 and the loaded pitch.

At block 710, the setup control circuitry 102 determines whether the target load restoration metric is satisfied. For example, the load restoration circuitry 208 determines that the target load restoration metric is satisfied when the current load restoration metric is greater than or equal to the target load restoration metric. In some examples, the load restoration circuitry 208 determines that the target load restoration metric is satisfied when a difference between the target load restoration metric and the current load restoration metric is less than a threshold (e.g., 1%, 5%, etc.). In response to the load restoration circuitry 208 determining that the target load restoration metric is satisfied (e.g., block 710 returns a result of YES), control returns to block 702. Alternatively, in response to the load restoration circuitry 208 determining that the target load restoration metric is not satisfied (e.g., block 710 returns a result of NO), control proceeds to block 712.

At block 712, the setup control circuitry 102 generates and/or outputs one or more alerts (e.g., the alert(s) 222 of FIG. 2) to an operator of the vehicle 100. For example, the example output control circuitry 210 of FIG. 2 can output the alert(s) 222 via the user interface 110 of FIG. 1 and/or via one or more of the indicators 118 to alert and/or inform a user that the target load restoration metric is not satisfied. In some examples, the alert(s) 222 can instruct the operator to adjust the hitch settings of the load-distributing hitch 304, to pull the vehicle 100 over to a side of the road, etc.

At block 714, the setup control circuitry 102 determines whether manual override has been detected. For example, the input interface circuitry 202 can detect manual override (e.g., by the operator) via the user input(s) 218 of FIG. 2. In some examples, the manual override halts output of the alert(s) 222 via the user interface 110 and/or the one or more indicators 118. In some examples, control returns to block 702.

At block 716, the setup control circuitry 102 restricts a speed of the vehicle 100 and/or locks the vehicle 100 in a parked position. For example, the vehicle control circuitry 212 restricts the vehicle speed (e.g., prevents travel of the vehicle 100 above a threshold speed) and/or locks the vehicle 100 in the parked position. In some examples, the vehicle speed is restricted and/or the vehicle 100 is locked in the parked position until the target load restoration is achieved (e.g., hitch settings of the load-distributing hitch 304 are adjusted).

FIG. 8 is a block diagram of an example programmable circuitry platform 800 structured to execute and/or instantiate the example machine-readable instructions and/or the example operations of FIGS. 6 and/or 7 to implement the setup control circuitry 102 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the input interface circuitry 202, the condition monitoring circuitry 204, the pitch calculation circuitry 206, the load restoration circuitry 208, the output control circuitry 210, the vehicle control circuitry 212, and the database 214.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 6 and/or 7, may be stored in the mass storage device 828, in the volatile memory 814, in the non-volatile memory 816, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that assist and/or facilitate setup of a load-distributing hitch used to couple a trailer to a vehicle. Disclosed examples obtain sensor data from existing image-based and/or radar-based sensors (e.g., camera(s), BLIS sensor(s), B-pillar sensor(s), etc.) of the vehicle, and determine a load restoration metric of the vehicle based on the sensor data. Disclosed examples generate and/or output example setup information based on a comparison between the determined load restoration metric and a target load restoration metric for the vehicle, where the setup information can instruct an operator whether and/or how to adjust hitch settings of the load-distributing hitch. As a result, disclosed examples can facilitate adjustment (e.g., by the operator) of the load-distributing hitch to ensure that the target load restoration metric is satisfied. Additionally, disclosed examples can continue monitoring the load restoration metric during travel and/or operation of the vehicle and trailer. In some examples, disclosed systems, apparatus, articles of manufacture, and methods improve the efficiency of using a computing device by determining and/or calculating the load restoration after detection of a condition associated with a vehicle, thus reducing the use of computational resources compared to when the load restoration is determined continuously and/or periodically (e.g., not in response to a detected condition). Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to facilitate setup of a load-distributing trailer hitch are disclosed herein. Further examples and combinations thereof include the following:

Example 1 includes an apparatus comprising interface circuitry, machine-readable instructions, and at least one processor circuit to be programmed by the machine-readable instructions to obtain sensor data from one or more sensors of a vehicle, the sensor data representative of distances to ground at respective locations of the vehicle, determine a pitch of the vehicle based on the sensor data, determine, based on the pitch, a load restoration metric associated with the vehicle, generate setup information based on a comparison of the load restoration metric to a target load restoration metric of the vehicle, and output the setup information via a user interface.

Example 2 includes the apparatus of example 1, wherein the one or more sensors include at least one of a B-pillar camera, a B-pillar radar sensor, a lidar sensor, a front camera, a rear camera, or a blind spot radar sensor.

Example 3 includes the apparatus of example 1, wherein the sensor data is first sensor data, the pitch is a first pitch, the distances to ground are first distances to ground when the vehicle is loaded, and one or more of the at least one processor circuit is to obtain second sensor data from the one or more sensors, the second sensor data representative of second distances to ground at the respective locations when the vehicle is unloaded, determine a second pitch of the vehicle based on the second sensor data, and determine the load restoration metric based on a difference between the first pitch and the second pitch.

Example 4 includes the apparatus of example 1, wherein one or more of the at least one processor circuit is to, in response to a determination that the target load restoration is not satisfied, at least one of restrict a speed of the vehicle or lock the vehicle in a parked position.

Example 5 includes the apparatus of example 1, wherein one or more of the at least one processor circuit is to detect, based on the sensor data, whether a condition associated with the vehicle has occurred, the condition to include at least one of a trailer being coupled to the vehicle, the vehicle coming to a stop, a load on the trailer being adjusted, or the trailer swaying relative to the vehicle, and determine the load restoration metric in response to a detection of the condition.

Example 6 includes the apparatus of example 1, wherein the setup information is to at least one of (a) instruct an operator to adjust load bar settings of a load-distributing trailer hitch coupled to the vehicle or (b) inform the operator that the target load restoration metric is satisfied.

Example 7 includes the apparatus of example 6, wherein one or more of the at least one processor circuit is to, in response to a determination that the target load restoration metric is satisfied, identify the load bar settings based on image data included in the sensor data, and cause storage of the load bar settings in a database.

Example 8 includes At least one non-transitory machine-readable medium comprising machine-readable instructions to cause at least one processor circuit to at least obtain sensor data from one or more sensors of a vehicle, the sensor data representative of distances to ground at respective locations of the vehicle, determine a pitch of the vehicle based on the sensor data, determine, based on the pitch, a load restoration metric associated with the vehicle, generate setup information based on a comparison of the load restoration metric to a target load restoration metric of the vehicle, and output the setup information via a user interface.

Example 9 includes the at least one non-transitory machine-readable medium of example 8, wherein the one or more sensors include at least one of a B-pillar camera, a B-pillar radar sensor, a lidar sensor, a front camera, a rear camera, or a blind spot radar sensor.

Example 10 includes the at least one non-transitory machine-readable medium of example 8, wherein the sensor data is first sensor data, the pitch is a first pitch, the distances to ground are first distances to ground when the vehicle is loaded, and the machine-readable instructions are to cause one or more of the at least one processor circuit to obtain second sensor data from the one or more sensors, the second sensor data representative of second distances to ground at the respective locations when the vehicle is unloaded, determine a second pitch of the vehicle based on the second sensor data, and determine the load restoration metric based on a difference between the first pitch and the second pitch.

Example 11 includes the at least one non-transitory machine-readable medium of example 8, wherein the machine-readable instructions are to cause one or more of the at least one processor circuit to, in response to a determination that the target load restoration is not satisfied, at least one of restrict a speed of the vehicle or lock the vehicle in a parked position.

Example 12 includes the at least one non-transitory machine-readable medium of example 8, wherein the machine-readable instructions are to cause one or more of the at least one processor circuit to detect, based on the sensor data, whether a condition associated with the vehicle has occurred, the condition to include at least one of a trailer being coupled to the vehicle, the vehicle coming to a stop, a load on the trailer being adjusted, or the trailer swaying relative to the vehicle, and determine the load restoration metric in response to a detection of the condition.

Example 13 includes the at least one non-transitory machine-readable medium of example 8, wherein the setup information is to at least one of (a) instruct an operator to adjust load bar settings of a load-distributing trailer hitch coupled to the vehicle or (b) inform the operator that the target load restoration metric is satisfied.

Example 14 includes the at least one non-transitory machine-readable medium of example 13, wherein the machine-readable instructions are to cause one or more of the at least one processor circuit to, in response to a determination that the target load restoration metric is satisfied, identify the load bar settings based on image data included in the sensor data, and cause storage of the load bar settings in a database.

Example 15 includes a method comprising obtaining sensor data from one or more sensors of a vehicle, the sensor data representative of distances to ground at respective locations of the vehicle, determining a pitch of the vehicle based on the sensor data, determining, based on the pitch, a load restoration metric associated with the vehicle, generating setup information based on a comparison of the load restoration metric to a target load restoration metric of the vehicle, and outputting the setup information via a user interface.

Example 16 includes the method of example 15, wherein the one or more sensors include at least one of a B-pillar camera, a B-pillar radar sensor, a lidar sensor, a front camera, a rear camera, or a blind spot radar sensor.

Example 17 includes the method of example 15, wherein the sensor data is first sensor data, the pitch is a first pitch, the distances to ground are first distances to ground when the vehicle is loaded, and further including obtaining second sensor data from the one or more sensors, the second sensor data representative of second distances to ground at the respective locations when the vehicle is unloaded, determining a second pitch of the vehicle based on the second sensor data, and determining the load restoration metric based on a difference between the first pitch and the second pitch.

Example 18 includes the method of example 15, further including, in response to a determination that the target load restoration is not satisfied, at least one of restricting a speed of the vehicle or locking the vehicle in a parked position.

Example 19 includes the method of example 15, further including detecting, based on the sensor data, whether a condition associated with the vehicle has occurred, the condition to include at least one of a trailer being coupled to the vehicle, the vehicle coming to a stop, a load on the trailer being adjusted, or the trailer swaying relative to the vehicle, and determining the load restoration metric in response to a detection of the condition.

Example 20 includes the method of example 15, wherein the setup information is to at least one of (a) instruct an operator to adjust load bar settings of a load-distributing trailer hitch coupled to the vehicle or (b) inform the operator that the target load restoration metric is satisfied.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
obtain sensor data from one or more sensors of a vehicle, the sensor data representative of distances to ground at respective locations of the vehicle;
determine a pitch of the vehicle based on the sensor data;
determine, based on the pitch, a load restoration metric associated with the vehicle;
generate setup information based on a comparison of the load restoration metric to a target load restoration metric of the vehicle; and
output the setup information via a user interface.

2. The apparatus of claim 1, wherein the one or more sensors include at least one of a B-pillar camera, a B-pillar radar sensor, a lidar sensor, a front camera, a rear camera, or a blind spot radar sensor.

3. The apparatus of claim 1, wherein the sensor data is first sensor data, the pitch is a first pitch, the distances to ground are first distances to ground when the vehicle is loaded, and one or more of the at least one processor circuit is to:
obtain second sensor data from the one or more sensors, the second sensor data representative of second distances to ground at the respective locations when the vehicle is unloaded;
determine a second pitch of the vehicle based on the second sensor data; and
determine the load restoration metric based on a difference between the first pitch and the second pitch.

4. The apparatus of claim 1, wherein one or more of the at least one processor circuit is to, in response to a determination that the target load restoration is not satisfied, at least one of restrict a speed of the vehicle or lock the vehicle in a parked position.

5. The apparatus of claim 1, wherein one or more of the at least one processor circuit is to:
detect, based on the sensor data, whether a condition associated with the vehicle has occurred, the condition to include at least one of a trailer being coupled to the vehicle, the vehicle coming to a stop, a load on the trailer being adjusted, or the trailer swaying relative to the vehicle; and
determine the load restoration metric in response to a detection of the condition.

6. The apparatus of claim 1, wherein the setup information is to at least one of (a) instruct an operator to adjust load bar settings of a load-distributing trailer hitch coupled to the vehicle or (b) inform the operator that the target load restoration metric is satisfied.

7. The apparatus of claim 6, wherein one or more of the at least one processor circuit is to, in response to a determination that the target load restoration metric is satisfied:
identify the load bar settings based on image data included in the sensor data; and
cause storage of the load bar settings in a database.

8. At least one non-transitory machine-readable medium comprising machine-readable instructions to cause at least one processor circuit to at least:
obtain sensor data from one or more sensors of a vehicle, the sensor data representative of distances to ground at respective locations of the vehicle;
determine a pitch of the vehicle based on the sensor data;
determine, based on the pitch, a load restoration metric associated with the vehicle;
generate setup information based on a comparison of the load restoration metric to a target load restoration metric of the vehicle; and
output the setup information via a user interface.

9. The at least one non-transitory machine-readable medium of claim 8, wherein the one or more sensors include at least one of a B-pillar camera, a B-pillar radar sensor, a lidar sensor, a front camera, a rear camera, or a blind spot radar sensor.

10. The at least one non-transitory machine-readable medium of claim 8, wherein the sensor data is first sensor data, the pitch is a first pitch, the distances to ground are first distances to ground when the vehicle is loaded, and the machine-readable instructions are to cause one or more of the at least one processor circuit to:
obtain second sensor data from the one or more sensors, the second sensor data representative of second distances to ground at the respective locations when the vehicle is unloaded;
determine a second pitch of the vehicle based on the second sensor data; and
determine the load restoration metric based on a difference between the first pitch and the second pitch.

11. The at least one non-transitory machine-readable medium of claim 8, wherein the machine-readable instructions are to cause one or more of the at least one processor circuit to, in response to a determination that the target load restoration is not satisfied, at least one of restrict a speed of the vehicle or lock the vehicle in a parked position.

12. The at least one non-transitory machine-readable medium of claim 8, wherein the machine-readable instructions are to cause one or more of the at least one processor circuit to:
detect, based on the sensor data, whether a condition associated with the vehicle has occurred, the condition to include at least one of a trailer being coupled to the vehicle, the vehicle coming to a stop, a load on the trailer being adjusted, or the trailer swaying relative to the vehicle; and
determine the load restoration metric in response to a detection of the condition.

13. The at least one non-transitory machine-readable medium of claim 8, wherein the setup information is to at least one of (a) instruct an operator to adjust load bar settings of a load-distributing trailer hitch coupled to the vehicle or (b) inform the operator that the target load restoration metric is satisfied.

14. The at least one non-transitory machine-readable medium of claim 13, wherein the machine-readable instructions are to cause one or more of the at least one processor circuit to, in response to a determination that the target load restoration metric is satisfied:
identify the load bar settings based on image data included in the sensor data; and
cause storage of the load bar settings in a database.

15. A method comprising:
obtaining sensor data from one or more sensors of a vehicle, the sensor data representative of distances to ground at respective locations of the vehicle;
determining a pitch of the vehicle based on the sensor data;
determining, based on the pitch, a load restoration metric associated with the vehicle;
generating setup information based on a comparison of the load restoration metric to a target load restoration metric of the vehicle; and
outputting the setup information via a user interface.

16. The method of claim 15, wherein the one or more sensors include at least one of a B-pillar camera, a B-pillar radar sensor, a lidar sensor, a front camera, a rear camera, or a blind spot radar sensor.

17. The method of claim 15, wherein the sensor data is first sensor data, the pitch is a first pitch, the distances to ground are first distances to ground when the vehicle is loaded, and further including:
obtaining second sensor data from the one or more sensors, the second sensor data representative of second distances to ground at the respective locations when the vehicle is unloaded;
determining a second pitch of the vehicle based on the second sensor data; and
determining the load restoration metric based on a difference between the first pitch and the second pitch.

18. The method of claim 15, further including, in response to a determination that the target load restoration is not satisfied, at least one of restricting a speed of the vehicle or locking the vehicle in a parked position.

19. The method of claim 15, further including:
detecting, based on the sensor data, whether a condition associated with the vehicle has occurred, the condition to include at least one of a trailer being coupled to the vehicle, the vehicle coming to a stop, a load on the trailer being adjusted, or the trailer swaying relative to the vehicle; and
determining the load restoration metric in response to a detection of the condition.

20. The method of claim 15, wherein the setup information is to at least one of (a) instruct an operator to adjust load bar settings of a load-distributing trailer hitch coupled to the vehicle or (b) inform the operator that the target load restoration metric is satisfied.
